(19) United States
(12) Patent Application Publication
(10) Pub. No.: US 2021/0261060 A1
(43) Pub. Date: Aug. 26, 2021

(54) Tailgate Steps

(71) Applicant: Randy Schwarz, Tomball, TX (US)

(72) Inventor: Randy Schwarz, Tomball, TX (US)

(21) Appl. No.: 16/891,651

(22) Filed: Jun. 3, 2020

Related U.S. Application Data
(60) Provisional application No. 62/979,251, filed on Feb. 20, 2020.

(51) Int. Cl. B60R 3/00; B60D 1/58; B60D 1/52

(52) U.S. Cl. CPC B60R 3/007; B60D 1/52; B60D 1/58

(57) ABSTRACT

This present invention discloses a step assembly for a vehicle to pivot downward, upward and rearward from the open tailgate in a working position for providing easier access to the cargo area. The step device includes a base and a slidable base upon which an arm is slidably mounted. At least one step member is located at a location opposite the pivoted ends. The device of the present invention provides vehicles with a hitch attachment capable of expanding into a set of steps, offering easy access into the truck bed. The device also allows to pivot approximately 90-degrees to expand the steps outward, and remains in a stationary position while the vehicle is in operation, allowing the device to remain secured but out of the way from other vehicles. The device further prevents injury and difficulty when trying to step up onto a tailgate or truck bed.

### CROSS-REFERENCE TO RELATED APPLICATION

The present application claims priority to, and the benefit of, U.S. Provisional Application No. 62/979,251, which was filed on Feb. 20, 2020 and is incorporated herein by reference in its entirety.

### BACKGROUND

The present invention relates generally to the field of vehicle steps or vehicle or cargo entry assists. More specifically, the present invention relates to a foldable, removable and extendable tailgate assembly product having one or more steps and adapted for installation to a tailgate, bumper or chassis of a vehicle such as a pickup truck, SUV, motorhome or the like. As used herein, the term “step assembly” refers to an arrangement that offers a simple, convenient, and risk-free method of entering and exiting the truck bed, gaining access to a roof rack that may be on a vehicle roof or other cargo box being carried by a vehicle. Accordingly, the present specification makes specific reference to the assembly described herein. However, it is to be appreciated that aspects of the present invention are also equally amenable to other similar applications, devices and methods of manufacture.

By way of background, small trucks for example, are commonly referred to as pickup trucks and are typically lighter trucks generally having an enclosed cab front portion and an open cargo area at back portion with low sides and/or a tailgate. A pick-up truck has been, for many years, one of the most economically important vehicles to the world's automotive industry. Consumers use pickup trucks for various purposes such as passenger transport, snow clearing, hauling, construction and off-road use to conventional automobile transmit activities. Pickup trucks are often marketed and used for their hauling (utilizing cargo bed) and towing (utilizing body on frame design and long wheelbase) capabilities. Further, pickup trucks are typically utilized in the construction industries and/or for residential purposes to transport bulk construction materials and/or other desired supplies. Most of these small truck vehicles are equipped with tailgates to facilitate loading and unloading of such materials and/or supplies from the truck bed. Usually, the height of truck bed or tailgate is at a height which is above knee level, 18 to 30 inches depending on the individual, with around 18 inches being relatively standard and can be difficult to reach. It should be understood that this invention is applicable to other vehicles having a high roof which may have a cargo or other carrier for which access is needed or even a traditional automobile sedan or station wagon where it may be useful to have a access assist device to allow an individual to step up and easily gain access to the roof or cargo rack. In addition, the present invention may also be suitable for use with recreational vehicles, (a.k.a. RVs) boats, trailers, SUVs, ATVs, and the like where being able to easily reach the top part of the vehicle is desirable.

While the variety, appearance and utility of pick-up truck accessories has increased dramatically over the years, a drawback to the overall vehicle design has been the relatively high positioning of the truck bed or cargo area relative to the ground. Many truck bed or cargo areas for an average “1 ton” truck is around 52 inches, with other models having a height of more than 60 inches. It causes difficulty to a user in climbing to reach into the truck bed, particularly if the individual is short. Increasing ruggedness and accessorizing of trucks has created many truck models with the truck bed positioned at too high a level difficult for an average individual to step easily into, and out of the truck bed. In case a truck user is loading heavy or bulky items into the vehicle, it is often necessary for the user to place the load on the tailgate, step into the bed of the truck, and then bend over to pick up the load and position the load where desired. Users frequently wish to enter the truck bed area to facilitate loading or unloading of items. The tailgate is typically several feet above the ground. For many users, this distance impedes comfortable entry into the bed area. In addition, accessing the cargo area or truck bed may be used for other purposes including social, such as watching an outdoor event, or riding in a parade, where providing easy access to multiple attendees may be fortuitous.

A person loading or unloading cargo from the pickup bed is therefore often forced to crawl or slide over the tailgate in an unnatural posture occasionally while carrying a significant amount of weight. Such user actions can cause serious and permanent back, neck, arm, leg and joint injuries. Even in the absence of injury, repeatedly entering and exiting a pickup bed, particularly with a load, can be exhausting and time-consuming. In such scenarios, people may end up hitting their knees, shins, feet, etc. on the tailgate and causing injury. Further, an unstable entry can be dangerous, leading to slips and falls when trying to step up onto the tailgate. Furthermore, jumping down directly from the tailgate to the ground may cause injury to the person. In addition, repeatedly placing a load directly on the tailgate can also potentially damage the tailgate causing it to not close correct or splay out of alignment with the truck body.

It has been known to employ steps to provide entry access to the interior of vehicles, such as recreational vehicles. It has also been known to provide step bumpers for facilitating entry access to a truck bed when the truck tailgate is in the closed or upward position. When such a step is unavailable, a user may use whatever assisting accessory that may be available, such as a step ladder, a cinder block, logs or similar items to aid entry into the bed area and facilitate loading of the truck. Such auxiliary items can also lead to injury as they are typically not secured to the truck and can tip over when attempting to climb on the auxiliary item.

As with many popular vehicles, various after-market accessories have become available. Bed accessories have become increasingly popular as a means for facilitating various uses for pick-up trucks. Consumers are presently offered a wide variety of tonneau covers, bed liners, tool boxes and truck caps for accessorizing their vehicles. In addition, step stools, step ladders, and other such devices are available in the state of the art to reduce awkwardness and strain of loading and unloading a pickup bed. However, a stool or ladder may be of insufficient height or strength, difficult to position securely on an uneven ground, inadvertently kicked out of position, and may become just another annoying, hard-to-reach piece of clutter rattling around in the back of the vehicle. Further, such unsecured and unstable stools and/or ladders cause injuries to the user utilizing it for stepping up and/or stepping down from the tailgate. In addition, unsecured clutter such as stools, ladders, etc. can also become airborne and potentially cause injury to other vehicles if hit by the flying step ladder. Therefore, the desirability of having a step to aid entry into a vehicle has long been recognized.

Various mounted bed extenders exist in the art to carry oversize equipment and provide support for a user to step up to the tailgate. There have been developed flush mounted extenders that are stowed in the tailgate when not in use. Some even provide downward rotation ability so the extender can be used as an assist step. Being out of sight when not in use presents a more attractive vehicle, but the part of the extender that acts as a step has generally been much narrower than is desired for a step creating additional risk of injury to the user. This is due to the fact that it is narrower or only about the same width as the thickness of the tailgate in order to allow the extender to retract within and remain flush with the tailgate. Another drawback with common bed extenders is that it interferes with or causes the elimination of the tailgate molding mounted on its top surface, further detracting the appearance of the vehicle.

Other existing solutions such as a step attached to a tailgate provide a more elegant solution to the problem. Most fold against the tailgate by rotating about fixed pins. Several are aftermarket add-ons that bolt or screw to a top edge of the existing tailgate. While these are relatively easy to install on existing tailgates, they protrude from a tailgate even when not in use, thereby interfering with loading and unloading of items from the truck bed and also allowing the device to interfere with other vehicles. Also, some step devices concentrate all loads on two small, unreinforced attachment points causing early damage of the step devices.

Therefore, there exists a long felt need in the art for a convenient, stable entry accessory that is well-suited for use with a truck tailgate. There is also a long felt need in the art for a pickup truck to have a tailgate with a truck bed extender having steps which are extendable generally upward, downward and rearward. Additionally, there is a long felt need in the art to provide a deployable tailgate step with a vertical height adjustment option to accommodate different users, different truck configurations and reduce the amount of inventory a manufacturer would need to supply and maintain. Additionally, there is a long felt need in the art for a tailgate step device that is convenient and easy for individuals to use when entering and exiting from a pickup truck bed. Finally, there is a long felt need in the art for a tailgate step product that allows the product to pivot approximately 90-degrees to expand the steps outward, and remains in a stationary position while the vehicle is in operation, allowing the product to remain secured in its position on the truck but out of the way from other vehicles.

The subject matter disclosed and claimed herein, in one embodiment thereof, comprises a tailgate step assembly which is a step assembly for pickup trucks. The tailgate step assembly is attached to a receiver hitch of the pickup truck via a pull-pin, pin latch, pin release or quick release mechanism. A receiver hitch may be applied by the vehicle manufacturer or alternatively by an aftermarket company specializing in such devices. A receiver hitch is used typically to connect a trailer to the vehicle. The device secures into the standard rear receiver hitch and is firmly secured with the pull-pin mechanism. The attachment rotates outward 90-degrees perpendicular or at a right angle from the tailgate to expand the steps. Users can access the steps to jump up into the truck bed or onto the tailgate when in a down position. The steps also allow the user to easily access and exit the truck bed without having to jump down thus avoiding injury. Once finished, the device can be rotated 90-degrees parallel to the truck bed to remain out of the way when not in use. The device offers a simple, convenient, and risk-free method of entering and exiting the truck bed.

In this manner, the tailgate step assembly of the present invention accomplishes all of the forgoing objectives, and provides a relatively convenient and easy solution for entering and exiting the truck bed. The improved tailgate step assembly of the present invention is also stable, extendable and easy to install and lock at any desired position, thereby reducing costs and improving overall manufacturing efficiencies. Finally, the improved tailgate step assembly of the present invention can be extended by the user to specifically accommodate different heights of a pickup truck bed for example from 52 inches to more than 60 inches depending on the make of the vehicle or the size of the individual intending to enter the truck bed or cargo area.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a tailgate step assembly which is a step assembly for pickup trucks. The step assembly includes at least one and preferably two step plates for providing access to the tailgate of the truck. The step assembly is attached to the receiver hitch of the vehicle via a pull pin, pin latch or pin or quick release mechanism. The device secures into the standard rear receiver hitch and is firmly secured with the pull pin or other fastener mechanism. The attachment rotates outward 90-degrees perpendicular from the tailgate to expand the steps. Users can access the steps to jump up into or exit the truck bed or onto the tailgate when in a down position. The steps also allow the user to easily exit the truck bed without having to jump down. Once finished, the device can be rotated 90-degrees parallel to the truck bed to remain out of the way when not in use. The device offers a simple, convenient, and generally risk-free method of entering and exiting the truck bed.

The subject matter disclosed and claimed herein, in one embodiment thereof, comprises a truck tailgate step attachment that is adapted to be mounted to an exterior surface of a truck tailgate. It consumes little space in truck bed area, folds easily into a compact, convenient stand-by position. The attachment of the present invention resists undesirable movement during use that could cause a user to lose his or her balance. Furthermore, in the stand-by or stowed position, the attachment presents no objectionable protrusions above the upper edge of the tailgate that could interfere with loading and unloading of items from the truck bed. Similarly, the attachment in its stand-by or stowed position does not adversely affect the appearance of the truck. In addition, the attachment which embodies the invention provides a convenient means for adjusting the height of the step above the ground to further ease the user's entry into the bed area.

In yet another embodiment, the tailgate assembly include multi-step structure to provide access to the tailgate and cargo area and easy loading and/or unloading of items from the trucks. The vehicle step assembly of the present invention is mountable to rear of the truck but may be mounted to other sides of the truck to provide access thereto depending on the preference of the user. In addition, depending on the vehicle, the step may be better positioned at a location other than on the rear of the vehicle. The vehicle step assembly provides access to the contents of a truck bed or cargo area from the rear of the truck when the tailgate is in either a raised or lowered position. Further, the invention is applicable to small trucks, pickup trucks, sport utility vehicles (SUVs), vans, trucks and other such vehicles. The shape of the step plates of the vehicle step assembly includes but are not limited to rectangular, square, etc. and may also include other shaped configurations such as team emblems or geometric structures to further accessorize the vehicle.

In one exemplary embodiment of the present invention, a vehicle step assembly, is provided and includes a base arm having a size and configuration to fit within a hitch or connection point on a vehicle. The base arm has a release pin to removably secure the step assembly to the hitch point. A sliding base is attached to the base arm and a support arm is movably connected to the sliding base. The support arm movable around an “X” axis and from a first position to a second position. A step portion is attached to the support arm and operable from a storage position to a use position.

In an exemplary embodiment of the present invention, a method for using a vehicle step assembly, is described and includes the steps of initially supplying a vehicle with a receiver portion fixedly connected to the vehicle. Then providing a vehicle step assembly, the vehicle step assembly including a first support arm, a second support arm pivotably connected to the first support arm and a step assembly connected to the second support arm. Next, the vehicle step assembly is inserted into the receiver portion of the vehicle and the second support arm is rotated from the first support arm from a non-use position to a use position. Then, actuating the step assembly to facility ingress or egress into the vehicle.

In a further exemplary embodiment, a tailgate step assembly, is presented and includes a vehicle having a tailgate operable from a first closed position to a second open position. The tailgate provides access to a cargo area and has a bumper disposed beneath the tailgate and a receiver hitch secured thereto such that the receiver hitch does not interfere with the operation of the tailgate. The assembly includes a first arm having a first length and sized and configured to be secured to the receiver hitch and a second arm having a second length longer than the first length of the first arm. The second arm is hingedly connected to the first arm by a sliding plate. A release pin secured to the second arm to the first arm, the release pin allowing the first arm and second arm to pivot relative to one another. A step assembly includes at least one step connected to the second arm opposite an end from the first arm, the at least one step being on the second arm

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of a tailgate step assembly of the present invention in accordance with the disclosed structure;

FIG. 2 illustrates a perspective view of the tailgate step assembly attached to a pickup truck hitch in accordance with the disclosed structure;

FIG. 3 illustrates a perspective view of the tailgate step assembly and associated steps arrangement in extended condition for use in accordance with the disclosed structure;

FIG. 4 illustrates a perspective view of a pin securement mechanism of the tailgate step assembly of the present invention in accordance with the disclosed structure; and

FIG. 5 illustrates a perspective view of one potential embodiment of a tailgate step assembly in an extended position, showing a person entering truck bed using tailgate step assembly in accordance with the disclosed invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for a convenient, stable entry accessory that is well-suited for use with a truck tailgate or other vehicle body element, e.g. bumper, sidewall panel, chassis, frame, etc. where it may be desirable to gain access to the roof or cargo area. There is also a long felt need in the art for a pickup truck to have a tailgate with a bed extender having one or more steps which are extendable upward, downward and rearward. Additionally, there is a long felt need in the art to provide a deployable tailgate step system with a vertical height adjustment option to accommodate different users, e.g. those of different heights, different truck configurations and reduce the amount of inventory a manufacturer would need to supply and maintain. Further, there is a long felt need in the art to provide a step assembly which resists interference with items such as cargo, supplies, loads, etc. while loading and/or unloading to the tailgate. Finally, there is a long felt need in the art for a vehicle step assembly that is convenient and easy for individuals to use when entering and exiting from a pickup truck bed.

The innovative product of the present invention features a tailgate step which is a step assembly for vehicles such as pickup trucks and the like. The step assembly is attached to a receiver hitch of the vehicle via a pull-pin or other pin or quick release mechanism. The device secures into the standard rear receiver hitch and is firmly secured with the pin. The attachment rotates outward 90-degrees perpendicular from the tailgate to expand the steps. Users can access the steps to climb up into the truck bed or onto the tailgate when in a down position. The steps also allow the user to easily exit the truck bed without having to jump down directly to the ground. Once finished, the device can be rotated 90-degrees parallel, 180-degree arc, e.g. left to right, to the truck bed to remain out of the way when not in use. The device offers a simple, convenient, and risk-free method of entering and exiting the truck bed.

The present invention, in one exemplary embodiment, is a truck tailgate step attachment that is adapted to be mounted to an exterior surface of a truck tailgate or other vehicle portion, bumper, chassis, etc., such as to a hitch element. It consumes little space in truck bed area and folds easily into a compact, convenient stand-by position. The attachment device of the present invention is stable, thereby resisting an undesirable movement during use that could cause a user to lose his or her balance and hit their knees, feet, legs, or other body party to the tail gate and therefore prevents causing any injury to the user or at least lessens the likelihood of injury. Furthermore, in the stand-by position, the attachment presents no objectionable protrusions above the upper edge of the tailgate or other body area, that could interfere with loading and unloading of items from the truck bed. Similarly, the attachment in its stand-by position does not adversely affect the appearance of the truck. In addition, the attachment which embodies the invention provides a convenient means for adjusting the height of the step above the ground to further ease the user's entry into the bed area.

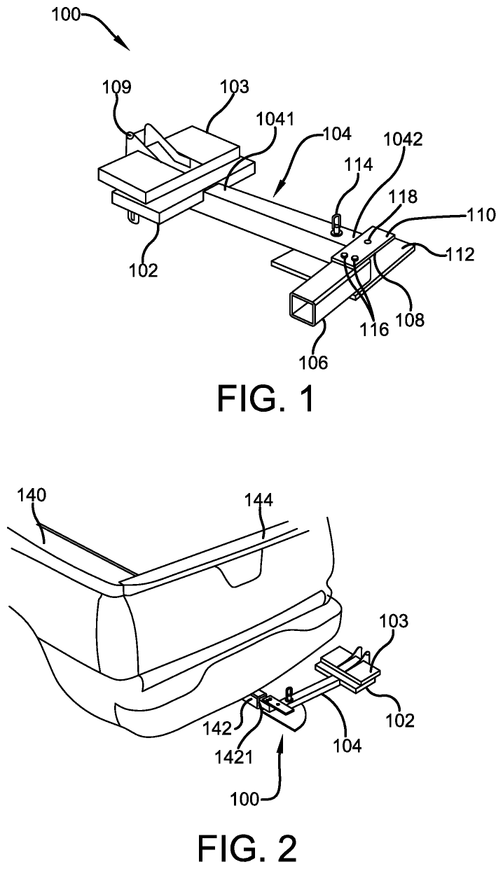

Referring initially to the drawings, FIG. 1 illustrates a perspective view of one possible embodiment of a tailgate step assembly of the present invention in accordance with the disclosed structure. Tailgate step assembly 100 preferably includes a two-step plate structure attached to an adjustable support arm 104 in order to attach to a pickup truck tailgate or other vehicle component, e.g. bumper. The present invention may include other step configurations, 1, 2, 3 or more steps as may be needed or desirable for the particular vehicle that the assembly is to be sold with. The two-step plate structure comprises plates on which a user can stand and which preferably includes a generally flat central portion for firm footing. The two-step plate structure comprises an upper step plate 102 and a lower step plate 103 are hingedly attached to a first end 1041 of an adjustable support arm 104, through a step hinge support 109. The upper step has an upper surface of the step portion and is positioned at a level equal to or above a surface of the support arm 104. The second step has an upper surface or step surface and is positioned below a level of the support arm. A second end 1042 of the adjustable support arm 104 is hingedly attached through a base hinge support 108 at a base arm 106 and to a support member 110, slidable within sliding base 112. The adjustable support arm 104 adjusts vertically from a pickup truck tailgate to the step plates 102 and 103, which in turn adjusts a distance from the ground or any other surface to the step plates 102 and 103. The first and second steps when in the use position, are offset laterally from one another to create a stepped configuration.

Further, the tailgate step assembly 100 includes the base 106 having a structure which is provided to be connected with a receiver hitch or other structure of a pickup truck or other vehicle by utilizing a pull-pin or quick pin release mechanism 114. The pull-pin mechanism 114 is a locking mechanism that keeps the step assembly 100 stable at an extended position. Further, the step assembly 100 includes hitch bolts 116 that are screwed to provide integration to various parts, and holes 118 are provided as slots for pull-pin mechanism 114 insert. The tailgate step assembly 100 can thus be folded at the respective hinge points 108 and 109 and slid into a stowed position within the tailgate of a pickup truck.

In an embodiment of the present invention, a lifting plate or cover (not shown) is preferably provided with the step assembly 100. The lifting plate or cover is mounted to either step plates 102, 103 or the first end 1041 of support arm 104, which may be used to pull tailgate step assembly 100 from its compact position when desired. When the tailgate step assembly 100 is in a compact position, a user can grip beneath an offset portion of the lifting cover to slide the working parts of the apparatus out of the vehicle tailgate. A main portion of the lifting cover preferably extends across an opening within which step assembly 100 is stored, preventing the entry of water, dirt and other debris. The design of the lifting plate or cover will vary based upon the design of a particular pickup truck's tailgate by the manufacturer, however, the function and utility will remain the same. The lifting cover may include a further lock mechanism for use in securing the step apparatus when in the compact position.

In a preferred embodiment, the upper step plate 102 and the lower step plate 103, are usually rectangular members having a plurality of texture regions, preferably defining protrusions that extend through a thickness of the step plates 102 and 103 and assist in providing friction that enhances a user's grip when stepping upon the step plates 102 and 103. The step plates may be other geometric shapes, circles, squares, or the like or alternatively may be shaped and configured to represent a specific theme such as a logo of a sports team, shape of a state, or other shape that a user may want to further accessorize the vehicle. Textured regions/protrusions may be of any suitable type of design or material to allow water, ice and debris to be cleared from the plate and to provide friction during use of the step plates 102 and 103. Variations in the material design of texture shall be within the scope of the present invention. The step plates 102 and 103 desirably comprises a structurally strong and/or light weight material. In certain embodiments, the step plates 102 and 103 comprises a fiber reinforced composite material such as a carbon fiber reinforced plastic or thermoplastic with, for example, a polymer matrix or resin. In alternative embodiment, the step plates 102 and 103 comprise other suitable composites, plastics, thermoplastics, metals, alloys, ceramics, among others, with efficacy, as needed or desired. The base hinge 108 and the step hinge 109 may be any suitable type of hinges known in the art, but is preferably fashioned such that the plates 102 and 103 may be folded down to about 90° relative to support arm 107. In particular, the step hinge 109 preferably acts as a support member and abuts against the underside surface of the step plate 103 when step plate 103 is positioned substantially 90° relative to the adjustable support arm 104. Further, in a preferred embodiment, the pull-pin or release pin structure mechanism 114 is utilized as a locking mechanism, however, it should be noted that this invention is not limited to pull-pin mechanism only, but rather extends to other types of locking mechanisms and removable fasteners known in the art.

In a preferred embodiment, the tailgate step assembly 100 is housed within an exterior surface of the pickup truck tailgate, however, alternative embodiments are contemplated wherein it is attached to an interior surface of the tailgate. The tailgate step assembly 100 may need to be modified based upon a particular design of the pickup truck's tailgate, to allow for installation.

FIG. 2 illustrates a perspective view of the tailgate step assembly attached to a conventional pickup truck hitch in accordance with the disclosed architecture. As shown in the FIG. 2, the tailgate step device 100 remains flush against the vehicle 150 when not in use. The tailgate step assembly 100 is attached to the receiver hitch 142 which is rigidly attached to frame or chassis of a pickup truck vehicle 150 via a lock mechanism 114, welds or other suitable methods of insuring a strong connection. The receiver hitch 142 is formed typically from metal and having a square or rectangular axial opening 1421. The opening 1421 is sized to receive a step assembly device 100 via a hitch pin or other locking mechanism (not shown) which is inserted into the receiver hitch. The tailgate step assembly 100 of the present invention is adapted to be mounted to the receiver hitch 12 in an analogous fashion.

The tailgate step assembly 100 secures into the standard rear receiver hitch 142 through the hitch opening 1421, and rotates outward 90-degrees perpendicular from the tailgate 144 to expand the step plates 102 and 103. The tailgate step assembly 100 of the present invention provides pickup trucks 150 with a receiver hitch 142 attachments capable of expanding into a set of steps 102 and 103, offering easy access into the truck bed. The installation of the tailgate step assembly 100 also allows the tailgate step assembly 100 to pivot approximately 90-degrees to expand the steps 102 and 103 outward, and remains in a stationary position while the pickup truck 150 is in operation, allowing the tailgate step assembly 100 to remain secured but out of the way from other vehicles. The stable structure of the device 100 further prevents injury and difficulty when trying to step up onto a tailgate 144 or truck bed.

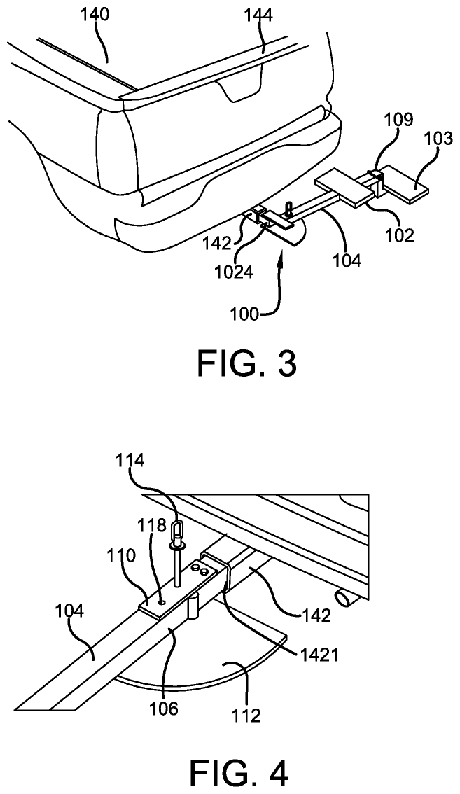

FIG. 3 illustrates a perspective view of the tailgate step assembly and associated steps arrangement in an extended condition for use in accordance with the disclosed architecture. The steps 102 and 103 can be extended by utilizing step hinge 109 to enable the user 130 to access the truck bed 140. The steps 102 and 103 allows the user 130 to easily enter or exit the truck bed 140 without having to jump down directly to the ground. Once the step assembly 100 has been utilized for a purpose, the tailgate step assembly 100 can be rotated 90-degrees parallel to the truck bed 140 to remain out of the way when not in use.

FIG. 4 illustrates a perspective view of a pin securement mechanism of the tailgate step assembly of the present invention in accordance with the disclosed architecture. The tailgate step assembly 100 is attached to the receiver hitch 142 of a pickup truck 150 via a pull pin locking mechanism 114. The tailgate step assembly 100 secures into the standard rear receiver hitch 142 and is firmly secured with the lock mechanism 114 in the form of pin. The attachment rotates outward 90-degrees perpendicular from the tailgate 144 to expand the steps 102 and 103. The receiver hitch 142 includes a square or rectangular axial opening 1421 which is sized to receive the base arm 106 of the step assembly device 100 via a hitch pin or other locking mechanism (not shown). The FIG. 4 shows the adjustment support 104 in an extended position.

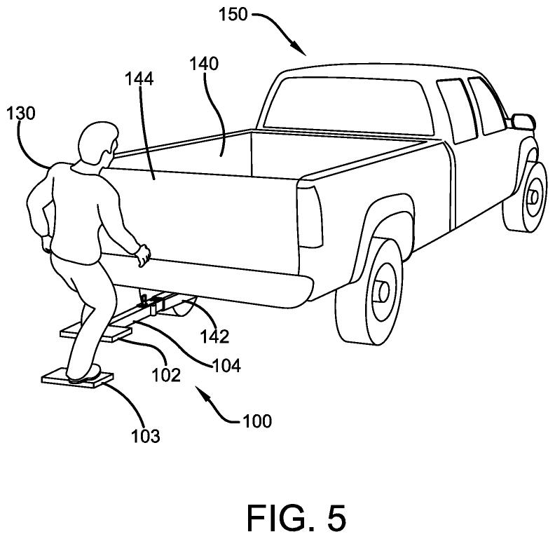

FIG. 5 illustrates a perspective view of one potential embodiment of a tailgate step assembly in an extended position, showing a person entering truck bed using the tailgate step assembly 100 in accordance with the disclosed architecture. A user 130 can access the steps 102 and 103 to access the pickup truck bed 140 or onto the tailgate 144 when the step assembly 100 is in an extended position. If the support arm 104 is long enough, the tailgate can be in the down position to allow a user to easily step on to the tailgate. In a shorter configuration, a user may need to swing their leg over the tailgate to gain entrance to the truck bed or cargo area. The steps 102 and 103 also allow the user 130 to easily exit the truck bed 140 without having to jump down directly to ground. Once the user has completed loading or unloading of the items to the truck bed 140 or the user has climbed up or down from the truck bed 140, the tailgate step assembly 100 can be rotated 90-degrees parallel to the truck bed 140 to remain out of the way when not in use. The tailgate step assembly 100 offers a simple, convenient, and risk-free method of entering and exiting the truck bed 140, and further utilizing the device 100 for various other purposes such as loading and/or unloading of supplies.

In operation, the tailgate step assembly 100 embodying the principles of the present invention is stored in a stand-by position secured to a truck tailgate 144. In the stand-by position, the tailgate 144 is in its upright or closed position. In this stand-by position, steps 102 and 103 lies in a closed position such that the foot surface of the steps 102 and 103 overlaps each other to minimize the space occupied by the attachment.

In an open horizontal position of the tailgate 144, the step assembly 100 is manually swung from its stand-by position to its operative position. Thus, adjustable support arm 104 is manually swung to the operative position wherein the adjustable support arm 104 hangs downwardly from the tailgate 144 toward the ground. Steps 102 and 103 are then manually swung to the operative position wherein they project outwardly from adjustable support arm 104 in disposition to support the foot of a user 130 to aid entry into the bed. If desired, an electric motor may be used to actuate the step assembly to allow a user to activate the system from inside the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “step device”, “step assembly”, “tailgate step assembly”, “step arrangement”, and “step apparatus” are interchangeable and refer to the tailgate step assembly 100 of the present invention. The terms “pull-pin mechanism” and “lock mechanism” also hold the same meaning as of 114 and can be used replaceable for each other. Also, the term “pickup truck” is used more often, but the broader term “vehicle” has also been used and should not create any confusion.

Notwithstanding the forgoing, the tailgate step assembly 100 of the present invention can be of any suitable size and configuration as is known in the art without affecting the overall concept of the invention, provided that it accomplishes the above stated objectives. One of ordinary skill in the art will appreciate that the size, configuration and material of the tailgate step assembly 100 as shown in the FIGS. are for illustrative purposes only, and that many other sizes of the tailgate step assembly 100 are well within the scope of the present disclosure. Although the dimensions of the tailgate step assembly 100 are important design parameters for user convenience, the tailgate step assembly 100 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle step assembly comprising;
a base arm having a size and configuration to fit within a hitch or connection point on a vehicle, the base arm having a release pin to removably secure the step assembly to the hitch point;
a sliding base attached to the base arm;
a support arm movably connected to the sliding base, the support arm movable around an “X” axis and from a first position to a second position; and
a step portion attached to the support arm and operable from a storage position to a use position.

2. A vehicle step assembly as recited in claim 1, wherein the support arm first position is 90-degrees distant from the support arm second position.

3. A vehicle step assembly as recited in claim 2, wherein the support arm first position is parallel to a vehicle body.

4. A vehicle step assembly as recited in claim 2, wherein the support arm second position is perpendicular to a vehicle body.

5. A vehicle step assembly as recited in claim 1, wherein the step portion includes first and second steps.

6. A vehicle step assembly as recited in claim 5, wherein each of the first and second steps has a textured or gripping surface.

7. A vehicle step assembly as recited in claim 1, wherein the step portion is a geometric shape.

8. A vehicle step assembly as recited in claim 1, wherein an upper surface of the step portion is positioned at a level equal to or above a surface of the support arm.

9. A vehicle step assembly as recited in claim 5, wherein the second step is positioned below a level of the support arm.

10. A vehicle step assembly as recited in claim 5, wherein the first and second steps when in the use position, are offset laterally from one another to create a stepped configuration.

11. A vehicle step assembly as recited in claim 1, wherein the vehicle is selected from one of a pickup truck, SUV, ATV, sedan, station wagon or a trailer.

12. A tailgate step assembly, comprising;
a vehicle having a tailgate operable from a first closed position to a second open position, the tailgate providing access to a cargo area;
a bumper disposed beneath the tailgate and having a receiver hitch secured thereto such that the receiver hitch does not interfere with the operation of the tailgate;
a first arm having a first length and sized and configured to be secure to the receiver hitch;
a second arm having a second length longer than the first length of the first arm, the second arm hingedly connected to the first arm by a sliding plate;
a release pin securing the second arm to the first arm, the release pin allowing the first arm and second arm to pivot relative to one another; and
a step assembly including at least one step connected to the second arm opposite an end from the first arm, the at least one step being on the second arm.

13. A tailgate step assembly as recited in claim 12, wherein the second arm pivots 90-degrees from the first arm via the sliding plate.

14. A tailgate step assembly as recited in claim 12, wherein the step assembly has one, two or three steps and each successive step is at a different height than each of the other one, two or three steps.

15. A tailgate step assembly as recited in claim 12, wherein the step assembly as a step that is disposed on a surface of the second support arm.

16. A tailgate step assembly as recited in claim 12, wherein the second support arm along with the step assembly pivots from a first non-use position to a second use position.

17. A method for using a vehicle step assembly, comprising the steps of;
supplying a vehicle with a receiver portion fixedly connected to the vehicle;
providing a vehicle step assembly, the vehicle step assembly including a first support arm, a second support arm pivotably connected to the first support arm and a step assembly connected to the second support arm;
inserting the vehicle step assembly into the receiver portion of the vehicle;
rotating the second support arm from the first support arm from a non-use position to a use position; and
actuating the step assembly to facility ingress or egress into the vehicle.

18. A method as recited in claim 17, wherein the step of actuating is pivoting the first arm from the second arm 90-degrees.

19. A method as recited in claim 17, wherein the step assembly includes one, two or three steps.

20. A method as recited in claim 17, wherein the vehicle step assembly further includes as sliding base and pin release securing the first arm to the second arm.
